(19) United States
(12) Patent Application Publication
(10) Pub. No.: US 2026/0261032 A1
(43) Pub. Date: Sep. 3, 2026

(54) ANTENNA BACK PLATE AND REMOTE CONTROL HAVING SAME

(71) Applicant: Wistron Corporation, New Taipei City (TW)

(72) Inventors: Jen Chieh CHENG, New Taipei City (TW); Wei Kuo LEE, New Taipei City (TW)

(21) Appl. No.: 19/181,552

(22) Filed: Apr. 17, 2025

(30) Foreign Application Priority Data
Mar. 3, 2025 (TW) 114107778

(51) Int. Cl. H01Q 1/08; H01Q 1/22; H01Q 1/42

(52) U.S. Cl. CPC H01Q 1/084; H01Q 1/22; H01Q 1/42

(57) ABSTRACT

An antenna back plate and a remote control having the same are provided. The remote control includes a main unit and an antenna back plate. The main unit includes a casing and a wireless module. The wireless module is disposed in the casing. The antenna back plate is rotatably connected to the casing, and includes a body, a pivotal connection member, and an antenna module. The pivotal connection member is pivotally connected to the body and the casing, so that the body is rotatable relative to the casing. The antenna module is disposed in the body, and is electrically connected to the wireless module of the main unit.

### CROSS-REFERENCE TO RELATED APPLICATION

This non-provisional application claims priority under 35 U.S.C. § 119(a) to Patent Application No. 114107778 filed in Taiwan, R.O.C. on March 3, 2025, the entire contents of which are hereby incorporated by reference.

### BACKGROUND

### Technical Field

The present disclosure provides an antenna back plate and a remote control having the same, and in particular, to an antenna back plate which can rotate relative to the remote control and a remote control having the same.

### Related Art

For long-distance (>5 km) signal transmission, most unmanned aerial vehicle (UAV) remote controls on the market are equipped with external antennas, which are classified into a removable antenna and a non-removable antenna. However, the removable antenna is usually aesthetically unpleasing and cannot be easily ornamented during designing. In addition, the removable antenna costs time for mounting or removal during use or storage, which causes inconvenience. The non-removable antenna has a limited length due to a need of folding, which affects a transmission distance. In addition, the non-removable antenna is usually customized, which needs high costs.

### SUMMARY

In view of the above problems, an embodiment of the present disclosure provides a remote control, which includes a main unit and an antenna back plate. The main unit includes a casing and a wireless module. The wireless module is disposed in the casing. The antenna back plate is rotatably connected to the casing, and includes a body, a pivotal connection member, and an antenna module. The pivotal connection member is pivotally connected to the body and the casing, so that the body is rotatable relative to the casing. The antenna module is disposed in the body, and is electrically connected to the wireless module of the main unit.

In some embodiments, the antenna back plate is used to be rotated between at least a first position and a second position relative to the casing. The first position is a position at which the antenna back plate covers a side surface of the casing. The second position is a position at which the antenna back plate is rotated 90 degrees relative to the side surface of the casing.

In some embodiments, the antenna back plate is further used to be rotated to a third position. The third position is a position at which the antenna back plate is rotated 180 degrees relative to the side surface of the casing.

In some embodiments, the side surface of the casing is provided with a protrusion that protrudes in a direction perpendicular to the side surface. One end of the pivotal connection member is locked to the protrusion.

In some embodiments, the body is provided with a recess. The recess is arranged corresponding to the protrusion of the casing. An other end of the pivotal connection member extends through an end of the recess.

In some embodiments, the antenna back plate further includes a connecting wire. The connecting wire extends out through the end of the recess, extends through the protrusion through an outer surface of the protrusion, and enters the casing, so that the wireless module is electrically connected to the antenna module.

In some embodiments, the protrusion is provided with a through hole. The through hole is provided on an end of the protrusion adjacent to the pivotal connection member. The connecting wire extends through the through hole and enters the casing.

In some embodiments, the antenna back plate further includes a fixing plate disposed on the body. The fixing plate is connected to the pivotal connection member.

In some embodiments, the antenna module is in a shape of a plate. A surface of the antenna module is at a spacing from an inner surface of the body the antenna module faces.

In some embodiments, the body of the antenna back plate includes a first housing and a second housing relative to each other along a first axis. A thickness from the first housing to the second housing in a direction of the first axis gradually decreases in a direction of a second axis. The second axis is perpendicular to the first axis.

In some embodiments, an inner side surface of the first housing is provided with a plurality of protruding ribs. Heights of the protruding ribs on the first axis gradually decrease in the direction of the second axis. The antenna module is in a shape of a plate and abuts against the protruding ribs, so that a surface of the antenna module is at a spacing from an inner side surface of the second housing.

In some embodiments, the pivotal connection member includes a pivoting member and two pivoting shafts. The two pivoting shafts are disposed parallel to the pivoting member. The pivoting member has a first long side, a first short side, a second long side, and a second short side connected in sequence. The two pivoting shafts are disposed on the first short side of the pivoting member, and are respectively adjacent to the first long side and the second long side.

In some embodiments, the antenna back plate is further used to be rotated to a fourth position. The fourth position is a position at which the antenna back plate is rotated 270 degrees relative to the side surface of the casing.

An embodiment of the present disclosure further provides an antenna back plate, which includes a body and an antenna module. The body includes a first housing and a second housing disposed opposite to each other along a first axis. The antenna module is disposed in the body and located between the first housing and the second housing. A thickness of the body in a direction of the first axis decreases in a direction of a second axis. The first axis is perpendicular to the second axis.

In some embodiments, the antenna module is in a shape of a plate. A surface of the antenna module is at a spacing from the second housing in the direction of the first axis.

In some embodiments, an inner side surface of the first housing is provided with a plurality of protruding ribs. Heights of the protruding ribs in the direction of the first axis gradually decrease in the direction of the second axis. The antenna module abuts against the protruding ribs, to cause all positions on the antenna module to be at a same spacing from an inner side surface of the second housing.

In some embodiments, the body is rotatably connected to a main unit. The antenna back plate is used to be rotated between at least a first position and a second position relative to the main unit. The first position is a position at which the antenna back plate covers a side surface of the main unit. The second position is a position at which the antenna back plate is rotated 90 degrees relative to the side surface of the main unit.

In some embodiments, the antenna back plate is further used to be rotated to a third position. The third position is a position at which the antenna back plate is rotated 180 degrees relative to the side surface of the main unit.

In some embodiments, the antenna back plate is further used to be rotated to a fourth position. The fourth position is a position at which the antenna back plate is rotated 270 degrees relative to the side surface of the main unit.

Another embodiment of the present disclosure provides a remote control, which includes a main unit and an antenna back plate. The main unit includes a casing and a wireless module. The wireless module is disposed in the casing. The antenna back plate is rotatably connected to the casing. The antenna back plate includes a body, a pivotal connection member, and an antenna module. The body includes a first housing and a second housing disposed opposite to each other along a first axis. The pivotal connection member is pivotally connected to the body and the casing, so that the body is rotatable relative to the casing. The antenna module is disposed in the body and located between the first housing and the second housing, and is electrically connected to the wireless module of the main unit. A thickness of the body in a direction of the first axis decreases in a direction of a second axis. The first axis is perpendicular to the second axis.

Based on the above, an embodiment provides a remote control, the antenna back plate thereof can be covered relative to the casing of the main unit of the remote control, so as to facilitate storing and carrying. To enhance a signal receiving function, the antenna back plate may be simply rotated to a desired angle (for example, to a second position by 90 degrees), to provide better wireless signal transmission or receiving performance. In addition, a rotation angle of the antenna back plate may be adjusted, based on a position of a desired control device, to achieve optimal wireless performance.

### BRIEF DESCRIPTION OF THE DRAWINGS

FIG. 1 is a three-dimensional view of a remote control according to some embodiments.

FIG. 2 is an exploded view of the remote control according to the embodiment of FIG. 1.

FIG. 3 is a schematic diagram in which an antenna back plate is rotated to a second position relative to a main unit according to the embodiment of FIG. 1.

FIG. 4 is a schematic diagram in which the antenna back plate is rotated to a third position relative to the main unit according to the embodiment of FIG. 1.

FIG. 5 is a partial enlarged view of a position represented by a symbol 5 in FIG. 2.

FIG. 6 is a partial sectional view of the antenna back plate along a cutting line 6-6 in FIG. 1.

FIG. 7 is a three-dimensional view of a remote control according to some other embodiments.

FIG. 8 is a partial exploded view of the remote control according to the embodiment of FIG. 7.

FIG. 9 is a schematic diagram in which the antenna back plate is rotated to a third position relative to a main unit according to the embodiment of FIG. 7.

FIG. 10 is a schematic diagram in which the antenna back plate is rotated to a fourth position relative to the main unit according to the embodiment of FIG. 7.

### DETAILED DESCRIPTION

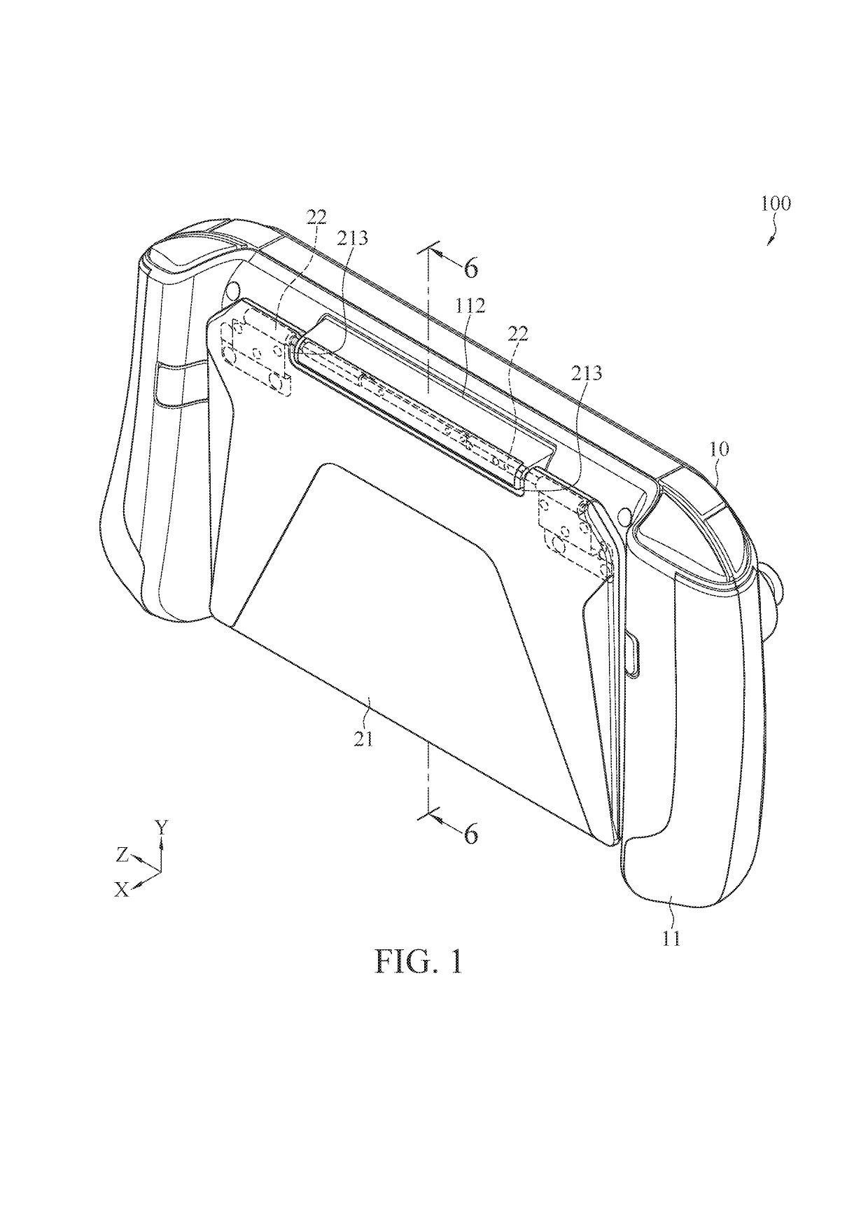

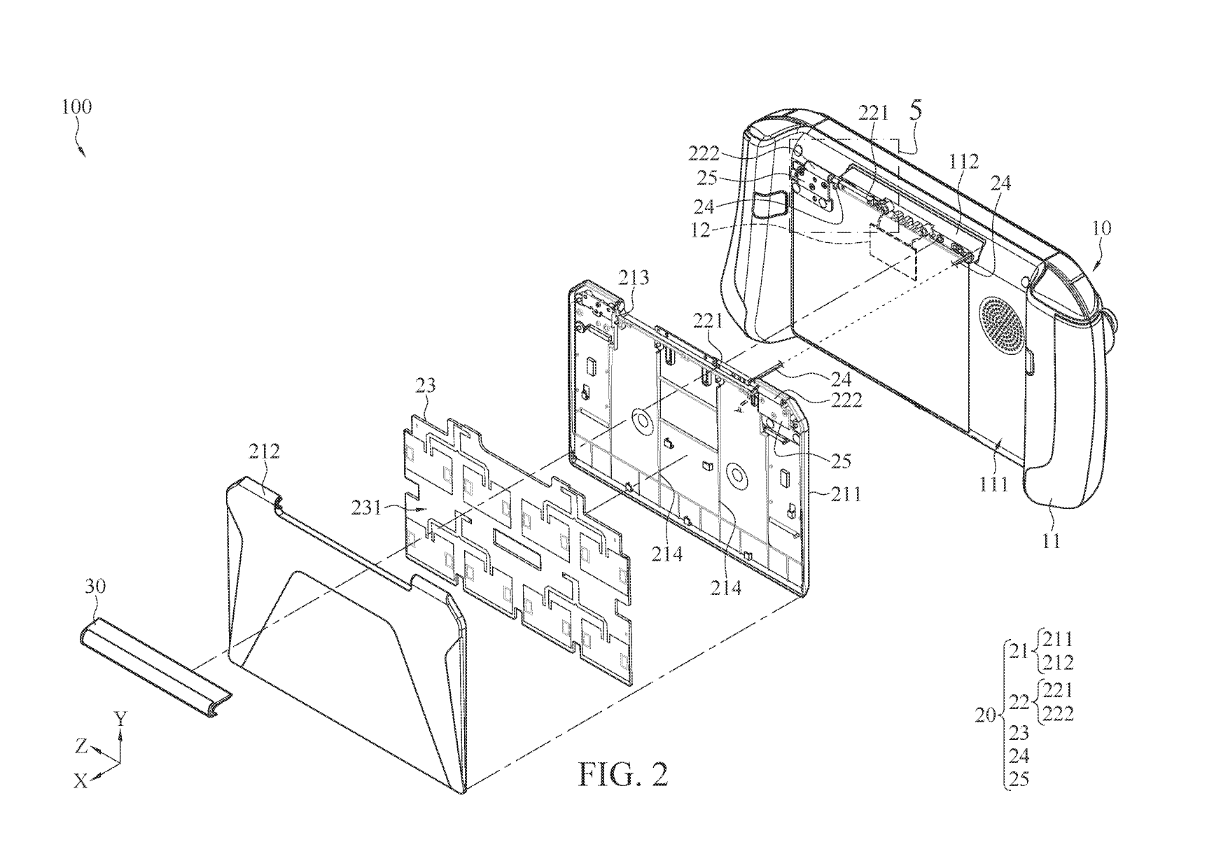

Reference is made to FIG. 1 and FIG. 2. FIG. 1 is a three-dimensional view of a remote control according to some embodiments. FIG. 2 is an exploded view of the remote control according to the embodiment of FIG. 1. A remote control 100 includes a main unit 10 and an antenna back plate 20. The main unit 10 includes a casing 11 and a wireless module 12. The wireless module 12 is arranged in the casing 11.

The antenna back plate 20 includes a body 21, a pivotal connection member 22, and an antenna module 23. The pivotal connection member 22 is pivotally connected to the body 21 and the casing 11, so that the body 21 is rotatable relative to the casing 11. The antenna module 23 is disposed in the body 21, and is electrically connected to the wireless module 12 of the main unit 10. An electrical connection manner between the antenna module and the wireless module may be, for example, in this embodiment, the antenna back plate 20 further includes a connecting wire 24. One end is connected to the antenna module 23, and an other end extends through the wireless module 12 and is connected to the body 21 and the casing 11. In this way, the wireless module 12 and the antenna module 23 are electrically connected.

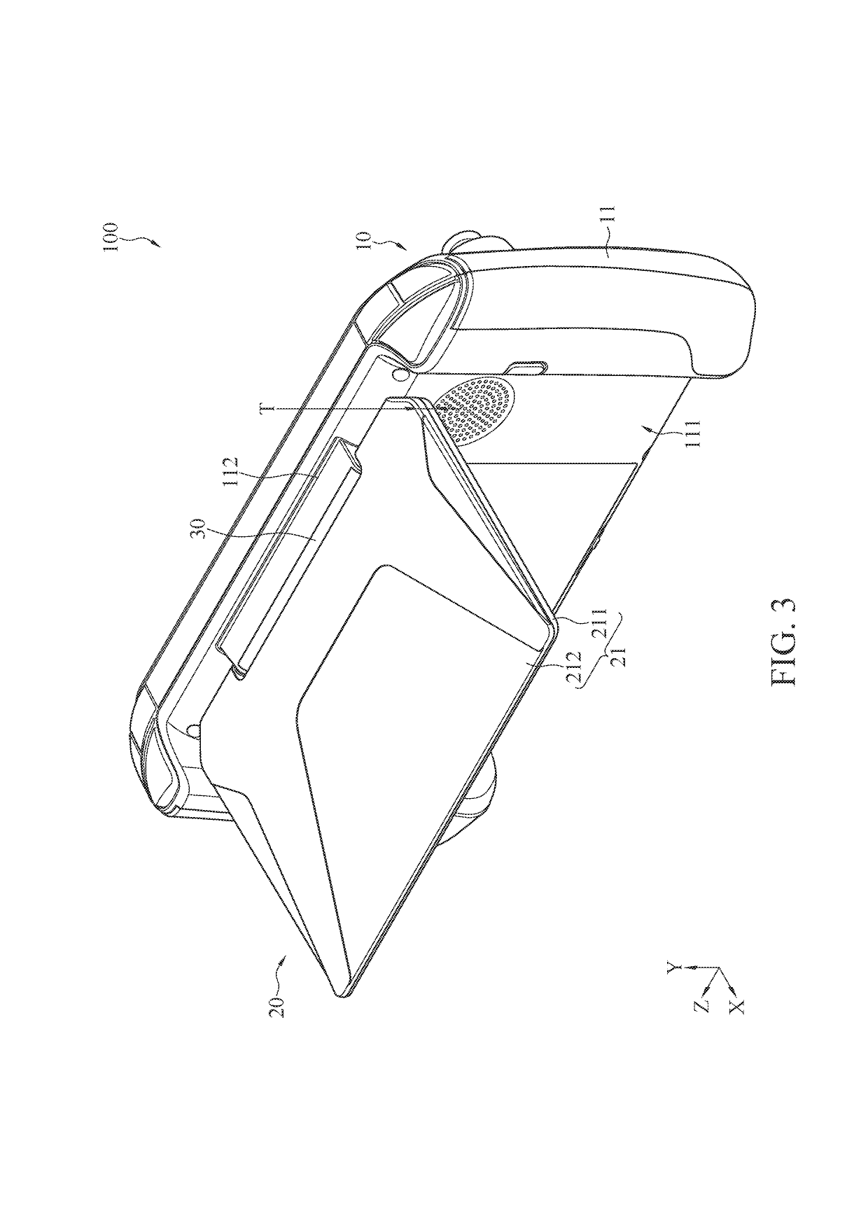

Referring to FIG. 3, FIG. 3 is a schematic diagram in which an antenna back plate is rotated to a second position relative to a main unit according to the embodiment of FIG. 1. An antenna back plate 20 is rotatably connected to a casing 11. The antenna back plate 20 is used to be rotated between at least the first position (as shown in FIG. 1) and the second position (as shown in FIG. 3) relative to the casing 11. As shown in FIG. 1 and FIG. 2, the first position is a position at which the antenna back plate 20 covers a side surface 111 of the casing 11. As shown in FIG. 3, the second position is a position at which the antenna back plate 20 arrives after being rotated by 90 degrees relative to the side surface 111 of the casing 11.

The body 21 of the antenna back plate 20 is pivoted to the casing 11 of the main unit 10 through a pivotal connection member 22, so that the antenna back plate 20 can be covered relative to the casing 11 of the main unit 10 of the remote control 100, thereby facilitating storing and carrying. To enhance a signal receiving function, the antenna back plate 20 may be simply rotated to a desired angle (for example, to a second position by 90 degrees), to provide better wireless signal transmission or receiving performance. Through a selection of the pivotal connection member 22, a pivotal connection member 22 that can stay at multiple angles is used. Further, a rotation angle of the antenna back plate 20 may be adjusted, based on a position of a desired control device, to place the antenna back plate 20 in any position between the first position and the second position to achieve optimal wireless performance.

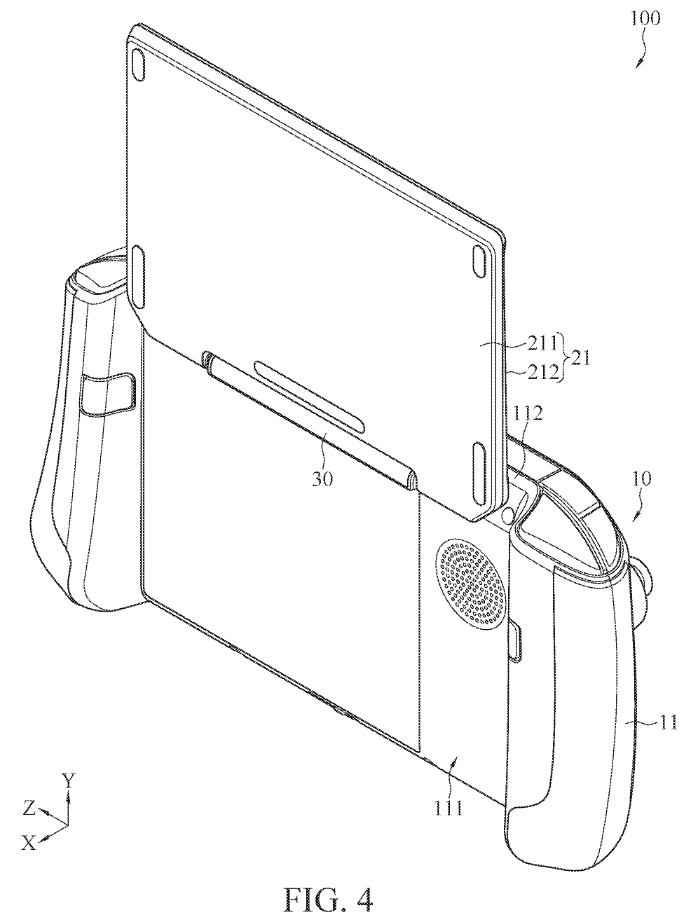

Referring to FIG. 4, FIG. 4 is a schematic diagram in which the antenna back plate is rotated to a third position relative to the main unit according to the embodiment of FIG. 1. An antenna back plate 20 may be further rotated to a third position. The third position is a position at which the antenna back plate 20 arrives after being rotated by 180 degrees relative to a side surface 111 of a casing 11 of a main unit 10. Through a selection of an appropriate pivotal connection member 22 and cooperation of the casing 11 and a body 21, the antenna back plate 20 may further be rotated to a larger angle relative to the casing 11 of the main unit 10, so that receiving and transmitting directions of an antenna signal can be adjusted at a wider angle. For example, in the control of an unmanned aerial vehicle (UAV) flying in the sky and the like, better signal transmission and reception performance can be obtained.

Next, referring to FIG. 2, for ease of description, a direction perpendicular to the side surface 111 of the casing 11 is defined as a first axis X, and a direction parallel to a short side of the side surface 111 of the casing 11 is defined as a second axis Y. The first axis X and the second axis Y are perpendicular to each other. In addition, a direction perpendicular to the first axis X and the second axis Y is defined as a third axis Z. The side surface 111 of the casing 11 is provided with a protrusion 112 that protrudes in the direction perpendicular to the side surface 111, i.e., a direction of the first axis X. One end 221 of the pivotal connection member 22 is locked to an end of the protrusion 112. That one side of the pivotal connection member 22 is disposed on the casing 11 and an other side of the pivotal connection member 22 is disposed on the body 21 in FIG. 2 is exemplified. The arrangement of the protrusion 112 enables the pivotal connection member 22 to be arranged to protrude from the casing 11, which increases an angle by which the antenna back plate 20 may be rotated relative to the casing 11. In addition, when the antenna back plate 20 is retracted to the side surface 111, the antenna back plate looks more attached to a back of the casing 11, so that an overall appearance is more complete and more beautiful. In this embodiment, two pivotal connection members 22 may be respectively arranged on two ends of the protrusion 112, but the present disclosure is not limited thereto.

Still referring to FIG. 2, the body 21 is provided with a recess 213. The recess is arranged corresponding to the protrusion 112 of the casing 11. Two ends of the recess 213 are correspondingly arranged on the two ends of the protrusion 112. An other end 222 of the pivotal connection member 22 extends through the end of the recess 213 and is connected to the body 21. The arrangement of the recess 213 on the body 21 enables the antenna back plate 20 to be assembled to the main unit 10 in a concave-convex fitting manner, to reduce a thickness in the direction of the first axis X. In addition, the two ends of the pivotal connection member 22 extend through the ends of the protrusion 112 and the ends of the recess 213, so that the pivotal connection member 22 can be effectively hidden while maintaining a function of the pivotal connection member 22, which maintains overall appearance consistency.

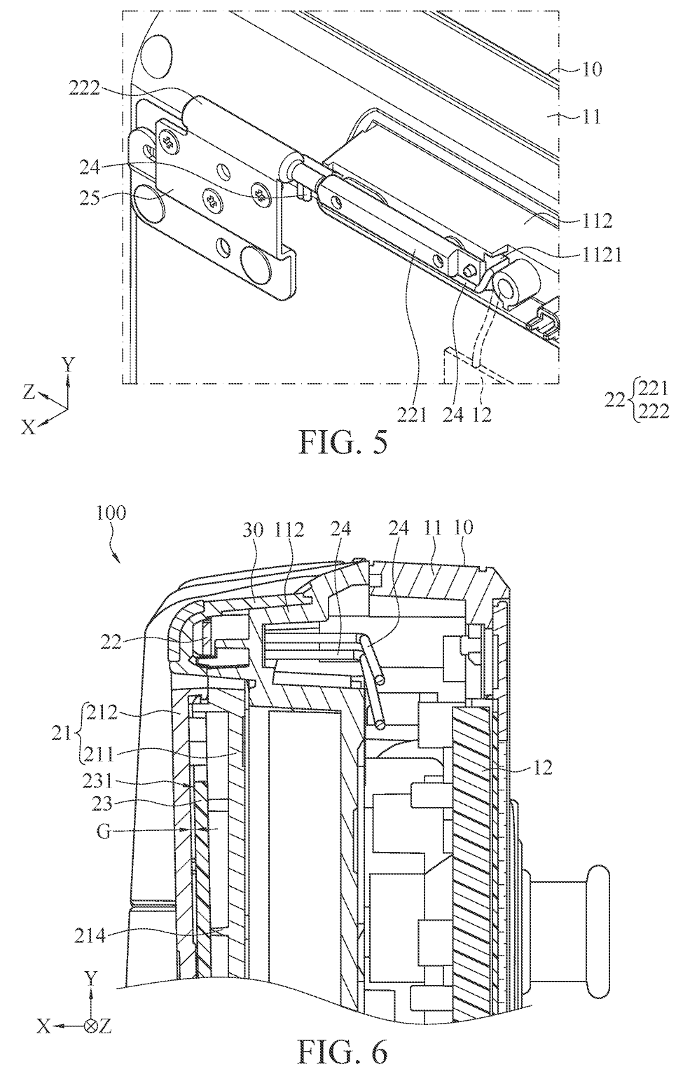

Referring to FIG. 2 and FIG. 5 together, FIG. 5 is a partial enlarged view of a position represented by a symbol 5 in FIG. 2. The connecting wire 24 extends out through the end of the recess 213, extends through the protrusion 112 after routing through an outer surface of the protrusion 112, and enters the casing 11, so that the wireless module 12 is electrically connected to the antenna module 23. In this embodiment, this embodiment includes two pivotal connection members 22, which is illustrated by the connecting wire 24 arranged on each side of the two pivotal connection members 22. However, in another embodiment, only one connecting wire 24 may extend out through one of the two ends of the recess 213, and then trace along the outer surface of the protrusion 112 through the protrusion 112, and enter the casing 11, so as to extend through the casing 11 and the body 21, and connect the wireless module 12 and the antenna module 23. By arranging the connecting wire 24 along the protrusion 112 and the recess 213, and further tracing along the outer surface of the protrusion 112, the connecting wire 24 can be mostly located on a stationary member (the protrusion 112), thereby reducing bending and pulling. However, the connecting wire 24 can also be effectively hidden by entering the body 21 from the end of recess 213.

It may be seen from FIG. 5 that the protrusion 112 is provided with a through hole 1121, which is arranged on an end of the pivotal connection member 22 away from the recess 213. In other words, the through hole is provided on an end 221 of the protrusion adjacent to the pivotal connection member 22, and the connecting wire 24 extends through the through hole 1121 and enters the casing 11. Specifically, the protrusion 112 is provided with a through hole 1121 at a position adjacent to one end 221 (i.e., relatively away from the recess 213) of the pivotal connection member 22. The connecting wire 24 enters the casing 11 from the side surface 111 of the casing 11 through the through hole 1121. In this embodiment, if the through hole 1121 herein is provided on a left side of one end 221 of the pivotal connection member 22, the through hole 1121 may be easily seen from the outside through a gap between the protrusion 112 and the recess 213. In addition, the connecting wire 24 extending through the through hole 1121 may also be bent through a gap between the protrusion 112 and the recess 213. In this embodiment, the through hole 1121 is provided on the protrusion 112 adjacent to the position of one end 221 of the pivotal connection member 22, so that the through hole 1121 can be hidden in the protrusion 112 through the arrangement of a decorative member 30. The connecting wire 24, even if pulled, is only be squeezed or limited between the protrusion 112 and the decorative member 30. However, the present invention is not limited thereto.

Still referring to FIG. 2, the antenna back plate 20 further includes a fixing plate 25. The fixing plate 25 is arranged on the first housing 211 of the body 21. The fixing plate 25 is locked to the first housing 211 and is connected to an other end 222 of the pivotal connection member 22 adjacent to the recess 213. The fixing plate 25 may be made of a relatively strong material than the body 21. For example, the body 21 is a lighter material such as plastic, while the fixing plate 25 may be made of a relatively strong material such as a metal sheet. In this way, the pivotal connection member 22 rotates relative to the relatively strong fixing plate 25, so that a relative movement of the pivotal connection member 22 directly with the body 21 of a plastic part can be avoided, which may cause damage to the plastic part and prolong a service life.

Next, referring to FIG. 2 and FIG. 6 together, FIG. 6 is a partial sectional view of the antenna back plate along a cutting line 6-6 in FIG. 1. The antenna module 23 is in a shape of a plate. A surface 231 of the antenna module 23 is at a spacing G from an inner surface of the body 21 which the antenna module 23 faces. The setting of the spacing G enables the antenna module 23 to maintain better performance.

Further, the body 21 of the antenna back plate 20 includes a first housing 211 and a second housing 212 engaged relative to each other along a first axis X. It may be seen from FIG. 3 that a thickness T from the first housing 211 to the second housing 212 in a direction of the first axis X gradually decreases in a second axis Y. In this way, an overall thickness of the antenna back plate 20 on a side where fewer mechanism elements are arranged may be thinned, so that the antenna back plate 20 looks more slender, concise, and meticulous, and does not feel too thick and bulky.

In addition, it may be seen from FIG. 2 and FIG. 6 that an inner side surface of the first housing 211 is provided with a plurality of protruding ribs 214. Heights of the protruding ribs 214 on the first axis X gradually decrease in the direction of the second axis Y. The antenna module 23 that is in a shape of a plate abuts against the protruding ribs 214, so that the surface 231 of the antenna module 23 is at the spacing G from the inner surface of the second housing 212. Further, each position of the surface 231 of the antenna module 23 can be spaced from the inner surface of the second housing 212 by the same spacing G as far as possible. In this way, wireless performance at each position on the antenna module 23 can be rendered as the same as possible.

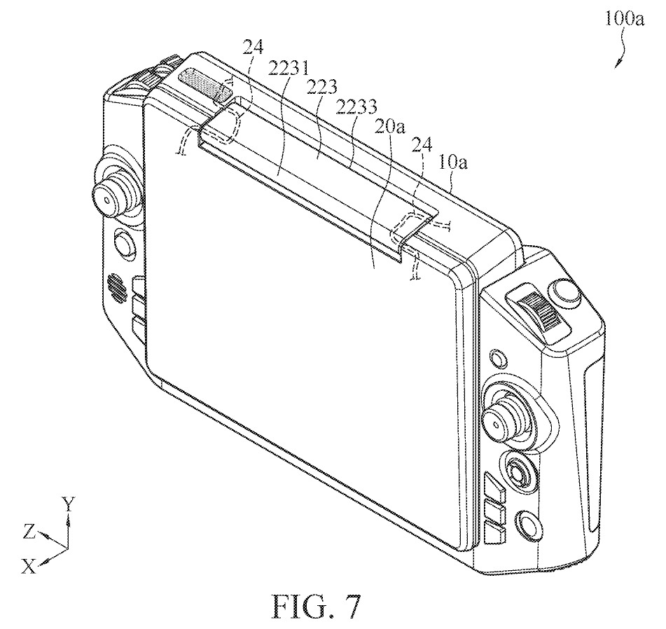

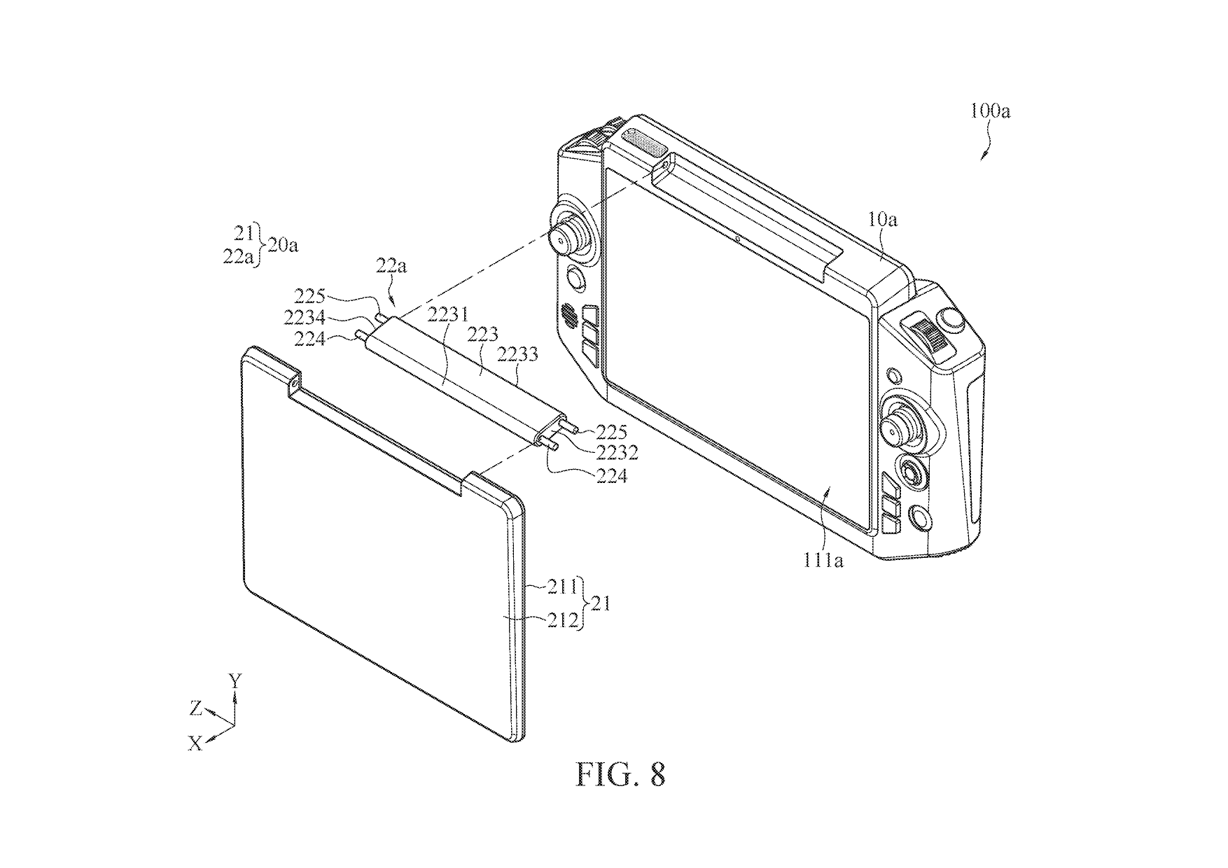

Next, referring to FIG. 7 and FIG. 8, FIG. 7 is a three-dimensional view of a remote control according to some other embodiments. FIG. 8 is a partial exploded view of the remote control according to the embodiment of FIG. 7. In this embodiment of FIG. 7, the same parts as in the embodiment of FIG. 1 are indicated by the same element symbols, and the corresponding connections are not described separately. The embodiment of FIG. 7 differs from the embodiment of FIG. 1 in that a pivotal connection member 22a of a remote control 100a further includes a pivoting member 223 and two pivoting shafts 224 and 225. The pivoting member 223 is provided with two parallel pivoting shafts 224 and 225. The pivoting member 223 has a first long side 2231, a first short side 2232, a second long side 2233, and a second short side 2234 connected in sequence. The two pivoting shafts 224 and 225 are arranged on the first short side 2232 of the pivoting member 223, and are respectively adjacent to the first long side 2231 and the second long side 2233. Specifically, the pivoting shaft 224 is arranged on the pivoting member 223 near the first short side 2232 of the first long side 2231, and the pivoting shaft 225 is arranged on the pivoting member 223 near the first short side 2232 of the second long side 2233. The two pivoting shafts 224 and 225 are arranged to form two rotation shafts arranged in parallel, so that a rotation angle of an antenna back plate 20a can be increased relative to a main unit 10a. In this embodiment, two sets of pivoting shafts 224 and 225 may be included, which are respectively arranged on the first short side 2232 and the second short side 2234, but the present disclosure is not limited thereto.

In addition, as shown in FIG. 7 and FIG. 8, the antenna back plate 20a in this embodiment further covers a side surface 111a of the main unit 10a, but is different from the side surface 111 that covers a back (a side that a screen is not arranged) of the main unit 10 in the previous embodiment. In this embodiment, the side surface 111a that covers a front of the main unit 10a is illustrated, such as a surface of a side that the screen is arranged. In this way, the antenna back plate 20a may be covered on the screen to simultaneously serve as a protective screen as being retracted in a first position.

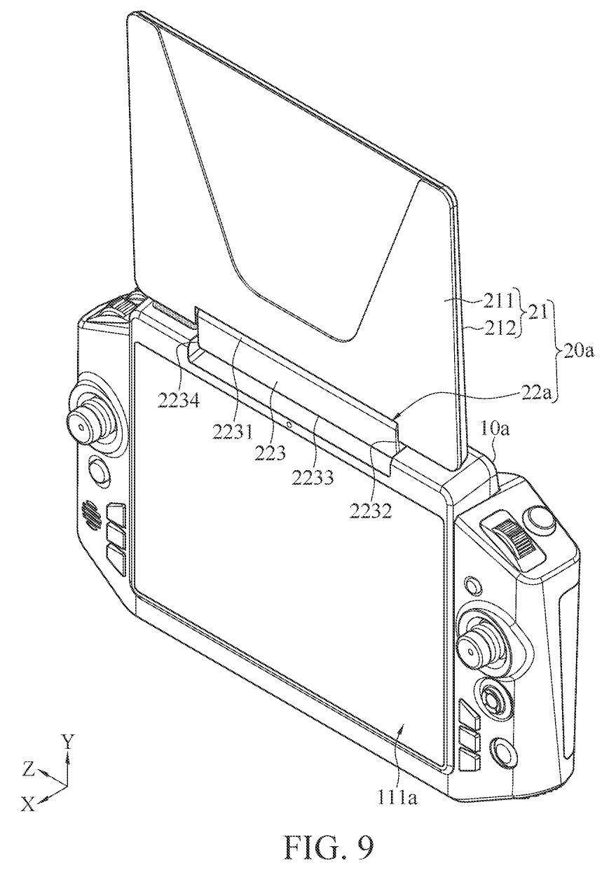

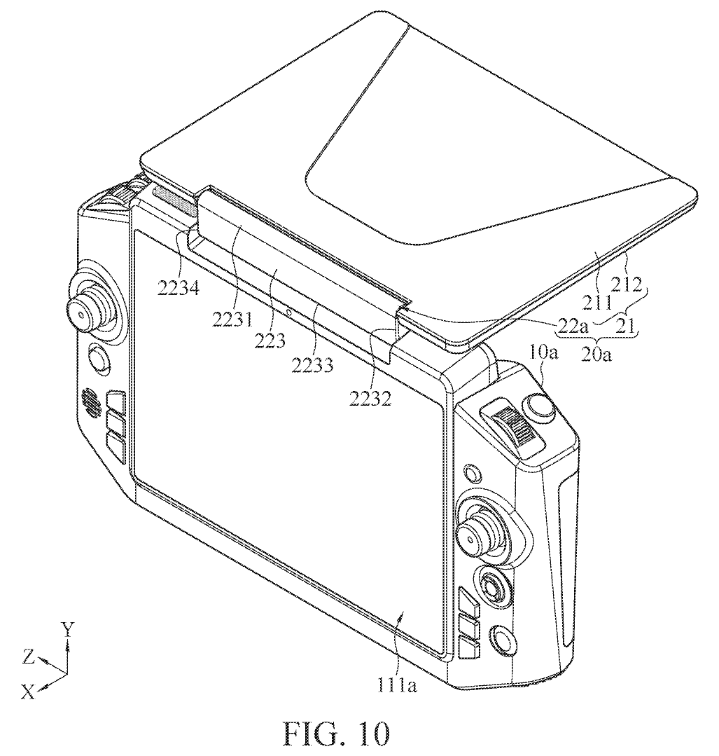

Next, referring to FIG. 9 and FIG. 10, FIG. 9 is a schematic diagram in which the antenna back plate is rotated to a third position relative to a main unit according to the embodiment of FIG. 7. FIG. 10 is a schematic diagram in which the antenna back plate is rotated to a fourth position relative to the main unit according to the embodiment of FIG. 7. In this embodiment, the antenna back plate 20a may alternatively be rotated to a second position by 90 degrees, or a position at which the antenna back plate 20a shown in FIG. 9 arrives after being rotated by 180 degrees relative to the side surface 111a of the main unit 10a. Further, as shown in FIG. 10, the antenna back plate 20a is further rotated to a fourth position. The fourth position is a position at which the antenna back plate 20a arrives after being rotated by 270 degrees relative to the side surface 111a of the main unit 10a. In this way, the antenna back plate 20a may further be rotated to a larger angle relative to the main unit 10a, so that receiving and transmitting directions of an antenna signal can be adjusted at a wider angle. For example, in the control of a UAV flying in the sky and the like, better signal transmission and reception performance can be obtained.

What is claimed is:

1. A remote control, comprising:
a main unit, comprising a casing and a wireless module, wherein the wireless module is disposed in the casing; and
an antenna back plate, rotatably connected to the casing and comprising:
a body;
a pivotal connection member, pivotally connected to the body and the casing, so that the body is rotatable relative to the casing; and
an antenna module, disposed in the body and electrically connected to the wireless module of the main unit.

2. The remote control according to claim 1, wherein the antenna back plate is rotated between at least a first position and a second position relative to the casing, the first position is a position at which the antenna back plate covers a side surface of the casing, and the second position is a position at which the antenna back plate is rotated 90 degrees relative to the side surface of the casing.

3. The remote control according to claim 2, wherein the antenna back plate is further rotated to a third position, and the third position is a position at which the antenna back plate is rotated 180 degrees relative to the side surface of the casing.

4. The remote control according to claim 3, wherein the side surface of the casing is provided with a protrusion that protrudes in a direction perpendicular to the side surface, and one end of the pivotal connection member is locked to the protrusion.

5. The remote control according to claim 4, wherein the body is provided with a recess arranged corresponding to the protrusion of the casing, and an other end of the pivotal connection member extends through an end of the recess.

6. The remote control according to claim 5, wherein the antenna back plate further comprises a connecting wire, the connecting wire extends out through the end of the recess, extends through the protrusion through an outer surface of the protrusion, and enters the casing, so that the wireless module is electrically connected to the antenna module.

7. The remote control according to claim 6, wherein the protrusion is provided with a through hole, the through hole is provided on an end of the protrusion adjacent to the pivotal connection member, and the connecting wire extends through the through hole and enters the casing.

8. The remote control according to claim 1, wherein the antenna back plate further comprises a fixing plate disposed on the body, and the fixing plate is connected to the pivotal connection member.

9. The remote control according to claim 1, wherein the antenna module is in a shape of a plate, and a surface of the antenna module is at a spacing from an inner surface of the body the antenna module faces.

10. The remote control according to claim 1, wherein the body of the antenna back plate comprises a first housing and a second housing engaged relative to each other along a first axis, a thickness from the first housing to the second housing in a direction of the first axis gradually decrease in a direction of a second axis, and the second axis is perpendicular to the first axis.

11. The remote control according to claim 10, wherein an inner side surface of the first housing is provided with a plurality of protruding ribs, heights of the protruding ribs on the first axis gradually decrease in the direction of the second axis, and the antenna module is in a shape of a plate and abuts against the protruding ribs, so that a surface of the antenna module is at a spacing from an inner surface of the second housing.

12. The remote control according to claim 3, wherein the pivotal connection member comprises a pivoting member and two pivoting shafts, the two pivoting shafts are disposed parallel to the pivoting member, the pivoting member has a first long side, a first short side, a second long side, and a second short side connected in sequence, and the two pivoting shafts are disposed on the first short side of the pivoting member, and are respectively adjacent to the first long side and the second long side.

13. The remote control according to claim 12, wherein the antenna back plate is further rotated to a fourth position, and the fourth position is a position at which the antenna back plate is rotated 270 degrees relative to the side surface of the casing.

14. An antenna back plate, comprising:
a body, comprising a first housing and a second housing disposed opposite to each other along a first axis; and
an antenna module, disposed in the body and located between the first housing and the second housing, wherein
a thickness of the body in a direction of the first axis decreases in a direction of a second axis, and the first axis is perpendicular to the second axis.

15. The antenna back plate according to claim 14, wherein the antenna module is in a shape of a plate, and a surface of the antenna module is at a spacing from the second housing in the direction of the first axis.

16. The antenna back plate according to claim 15, wherein an inner side surface of the first housing is provided with a plurality of protruding ribs, heights of the protruding ribs in the direction of the first axis gradually decrease in the direction of the second axis, and the antenna module abuts against the protruding ribs, to cause all positions on the antenna module to be at a same spacing from an inner side surface of the second housing.

17. The antenna back plate according to claim 14, wherein the body is rotatably connected to a main unit, the antenna back plate is rotated between at least a first position and a second position relative to the main unit, the first position is a position at which the antenna back plate covers a side surface of the main unit, and the second position is a position at which the antenna back plate is rotated 90 degrees relative to the side surface of the main unit.

18. The antenna back plate according to claim 17, wherein the antenna back plate is further rotated to a third position, and the third position is a position at which the antenna back plate is 180 degrees relative to the side surface of the main unit.

19. The antenna back plate according to claim 18, wherein the antenna back plate is further rotated to a fourth position, and the fourth position is a position at which the antenna back plate is 270 degrees relative to the side surface of the main unit.

20. A remote control, comprising:
a main unit, comprising a casing and a wireless module, wherein the wireless module is disposed in the casing; and
an antenna back plate, rotatably connected to the casing and comprising:
a body, comprising a first housing and a second housing disposed opposite to each other along a first axis;
a pivotal connection member, pivotally connected to the body and the casing, so that the body is rotatable relative to the casing; and
an antenna module, disposed in the body, located between the first housing and the second housing, and electrically connected to the wireless module of the main unit, wherein
a thickness of the body in a direction of the first axis decreases in a direction of a second axis, and the first axis is perpendicular to the second axis.
